(19) United States
(12) Patent Application Publication
(10) Pub. No.: US 2024/0346946 A1
(43) Pub. Date: Oct. 17, 2024

(54) MASS GENERATION OF CONTENT FOR EDUCATION APPLICATIONS

(71) Applicant: Acapedia, LLC, Katy, TX (US)

(72) Inventor: Alexander S. PASCIAK, Katy, TX (US)

(21) Appl. No.: 18/638,162

(22) Filed: Apr. 17, 2024

Related U.S. Application Data
(60) Provisional application No. 63/459,995, filed on Apr. 17, 2023.

(51) Int. Cl. G09B 7/06; G06F 40/166; G06F 40/40

(52) U.S. Cl. CPC G09B 7/06; G06F 40/166; G06F 40/40

(57) ABSTRACT

Systems, devices, methods, and instructions for generation of content for an education application, including periodically web-scraping a repository of learning content, storing the learning content and corresponding information, language processing the learning content using a neural network architecture, using artificial intelligence or machine learning to summarize the learning content, and using artificial intelligence or machine learning to generate one or more questions and answers for the education application based on the learning content.

### PRIORITY INFORMATION

This application claims the benefit of U.S. Provisional Patent Application No. 63/459,995 filed on Apr. 17, 2023, which is hereby incorporated by reference in its entirety.

### FIELD OF THE INVENTION

The embodiments of present invention generally relate to online learning, and more particularly to mass content generation, storage, and retrieval for education applications (e.g., continuing education applications). In the various embodiments, an open market concept for crowd sourcing may be used for content generation. In the various embodiments, artificial intelligence and/or machine learning may be used for content generation.

### DISCUSSION OF THE RELATED ART

It is well known in medicine and other professional disciplines that the rapid rate of research far exceeds that which may be reasonably learned by any professional in their continuing education practices. For example, in 2005, a systematic review in the Annals of Internal Medicine made headlines when most studies found a correlation between increasing years in practice and decreasing quality of care in medicine. The article suggested that the longer physicians have been in practice, the less likely they were to adhere to updated clinical guidelines, leading to worse patient outcomes. Building upon this, a 2011 study estimated that the doubling time of medical knowledge in 1950 was 50 years; in 1980, 7 years; and in 2010, 3.5 years. In 2020, it was projected to have been just 73 days. In turn, this statistic means that what was learned in the first 3 years of medical school is just 6% of what was known at the end of the decade from 2010 to 2020.

These examples demonstrate a problem-namely, that it is nearly impossible for physicians and other professionals to keep up with the high rate of advancement in their respective fields. Education applications (e.g., continuing education applications) and programs have a limited supply of educational materials and cannot keep up with this increasingly high rate of advance in a variety of disciplines.

To the inventor's knowledge, no one is using a free-market crowdsourcing model or an artificial intelligence and/or machine learning system for developing content for educational applications for physicians or other professionals. As a result, existing education applications and programs are significantly lacking in the breadth and depth of the content they offer.

### SUMMARY OF THE INVENTION

Accordingly, the embodiments of the present invention are directed to mass generation of content for education applications that substantially obviates one or more problems due to limitations and disadvantages of the related art. In the various embodiments, an open market concept for crowd sourcing may be used for content generation. In the various embodiments, artificial intelligence and/or machine learning may be used for content generation.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the mass generation of content for education applications, such as continuing medical education (CME), includes systems, devices, methods, and instructions for generation of content for an education application, including periodically web-scraping a repository of learning content, storing the learning content and corresponding information, language processing the learning content using a neural network architecture, using artificial intelligence or machine learning to summarize the learning content, and using artificial intelligence or machine learning to generate one or more questions and answers for the education application based on the learning content.

In another example, the mass generation of content for education applications, such as continuing medical education (CME), using an open market concept for crowdsourcing includes systems, devices, methods, and instructions for mass generation of content for continuing education using crowdsourcing.

In another example, the mass generation of content for education applications, such as continuing medical education (CME), using an open market concept for crowdsourcing includes systems, devices, methods, and instructions for mass generation of content for continuing education using crowdsourcing and machine learning and/or artificial intelligence.

In another example, the mass generation of content for education applications, such as continuing medical education (CME), using an open market concept for crowdsourcing includes systems, devices, methods, and instructions for mass generation of content for continuing education using machine learning and/or artificial intelligence.

It is to be understood that both the foregoing general description and the following detailed description are examples and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A illustrates a flow diagram of functionality for generating educational content according to an example embodiment of the present invention.

FIG. 1B illustrates a flow diagram of functionality for generating educational content according to another example embodiment of the present invention.

FIG. 2 illustrates an example user interface according to an example embodiment of the present invention.

FIG. 3 illustrates a flow diagram of functionality for continuing education according to an example embodiment of the present invention.

FIG. 4 illustrates an example user interface according to an example embodiment of the present invention.

FIG. 5 illustrates a representative architecture of a portable electronic device according to an example embodiment.

FIG. 6 illustrates an example user interface according to an example embodiment of the present invention.

### DETAILED DESCRIPTION OF THE EXEMPLARY EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using a device are described. In some embodiments, the device is a portable communication device (e.g., a mobile phone or tablet). The user interface may include a touch screen, a gyroscopic or other acceleration device, and/or other input/output devices. In the discussion that follows, a portable communications device is used as an example embodiment. It should be understood, however, that the user interfaces and associated methods may be applied to other devices, such as personal computers and laptops, that may include one or more other physical user-interface devices, such as a keyboard and or mouse.

The portable communication device may support a variety of applications, such as telephone, text messenger, calendar, and (continuing) education applications. The various applications that may be executed on the device may use at least one common physical user-interface device, such as a touch screen. One or more functions of the touch screen as well as corresponding information displayed on the device may be adjusted and/or varied from one application to another and/or within a respective application. In this way, a common physical architecture of the device may support a variety of applications with user interfaces that are intuitive and transparent. In the discussion that follows, an education application (e.g., a continuing education application) is used as an example embodiment, but it should be understood that the user interfaces and associated methods may be applied to a variety of education applications (e.g., professional, academic, etc.) and other applications. Although medical education is described as an example, the embodiments may be readily applied to other professional education (e.g., law, financial, regulatory, data privacy, accounting, engineering, etc.).

Currently, education applications and programs have a limited supply of educational materials and cannot keep up with the increasingly high rate of advances in respective disciplines. Until now, generation of content for education applications has been a painstaking manual task. As a result, continuing education in highly specialized disciplines is limited.

Recently, advances have been made in artificial intelligence and machine learning such that computers are beginning to demonstrate the ability to replicate human communication. For example, ChatGPT is a chatbot developed by OpenAI and launched on Nov. 30, 2022. Using large language models, it enables users to refine and develop a conversation having a desired length, format, style, level of detail, and language. Despite recent advances, ChatGPT and other artificial intelligence tools sometimes provide plausible sounding but ultimately incorrect feedback. Accordingly, artificial intelligence and/or machine learning content still needs to be verified by a human user.

In an example embodiment, the education application (e.g., a continuing education application) is a free-market based system for crowdsourcing of mass content for continuing education for physicians or other professionals. Using professionals in respective disciplines (or industries), the embodiments guide professionals in respective fields through a process of content submission, taking advantage of open access research and guidelines published in peer-reviewed high-impact journals. Submissions are reviewed and once accepted, a payout is sent to the submitter. Specific articles may be awarded with a higher payout thus using the ‘free-market’ to ensure content in the necessary subjects is acquired.

Although journal articles are used as an example of scholarly content (or learning content), the various embodiments of the invention may be readily applied to any form of scholarly content, such as medical/scientific journals, engineering journals, text books, text book chapters, white papers, legal opinions, legal regulations, business case studies, accounting regulations, etc.

Professionals may be recruited and on-boarded as contractors and join using a web-based or mobile application interface. As these professionals are currently practicing in their profession (let us assume this is limited to medicine for the sake of discussion, but the embodiments are not so limited), then they bring with them expertise in one or more areas of the medical arts. Herein, such professionals are referred to as “submitters”, as they are submitting content to the platform.

A submitter logs into the interface and is presented with a free-market list of payouts in table format. The payouts are per approved/accepted submission. Some factors that may affect (e.g., increase or decrease) the payout price of a submission are the medical specialty and subspecialty (e.g., a higher payout is offered for specialties which are lacking in content), submissions from higher impact (more renowned) medical journals, submissions from special topics in medicine (example, opiate prescribing best practices), number of citations of the article, reputation of the submitter, etc. Based on the submitter's individual area of expertise and the free-market payouts, they may select a subject that they wish to submit content on.

In the medical context, PubMed can be utilized. Other sources can be used including the Journal's or publisher's website. PubMed is a free database including primarily references and abstracts on life sciences and biomedical topics. The site is operated by the National Library of Medicine and the National Institutes of Health. There submitters look for research articles, meta-analyses, review articles, and practice guidelines which meet their area of interest and/or their desired payout. They select a research article and review it.

Once they have reviewed the article, they are guided through a “submitters” workflow on the app where they enter key information about the article, such as the PubMed ID (to facilitate automated download of article content), entering the medical specialties and subspecialties to which the article best applies, entering relevant keywords for the article, and finally, writing a series of multiple choice questions which are used as part of a continuing-medical education activity focused on the article.

The journal articles and corresponding data, such as title, abstract, authorship, key words, metadata, article text and figures, submitter information, and submitter generated questions, can be stored on one or more web-servers and/or one or more cloud-based storage systems.

Submitted articles are put through a multi-level peer-review process, and once final approval of the content is received, an automated payment corresponding to the free-market rate is sent to the submitter.

In another example embodiment, the education application (e.g., a continuing education application) includes an artificial intelligence and/or machine learning system for generation of mass content. For example, the education application can be a continuing education application for physicians or other professionals.

Using any of a variety of commercially-available web-scraping applications (e.g., PubMed Web Scraper, ParseHub, Diffbot, etc.), periodically (e.g., daily, weekly, monthly, quarterly, etc.) retrieving journal articles published in peer-reviewed high-impact journals, and available for download via an Internet-based repository (e.g., a database). The retrieved journal articles and corresponding data (e.g., title, abstract, authorship, key words, metadata, article text and figures, etc.) can be stored on one or more web-servers and/or one or more cloud-based storage systems. Other scholarly content or learning content can be retrieved and stored. Although journal articles are used as an example, the embodiments are not so limited.

In this embodiment, instead of using professionals in respective disciplines (or industries), the embodiment utilizes any of a variety of commercially-available artificial intelligent and/or machine learning tools (e.g., ChatGPT, ChatDoc, ChatPDF, Unriddle, etc.) to language process the retrieved journal articles using a neural network architecture, for example. In most artificial intelligence or machine learning models, the neural networks enable language processing through complex mathematical functions utilizing numerical data as input. Therefore, the language processing encodes the input text into numerical data before being supplied to the neural network. Similarly, the numerical output of the neural networks is decoded to natural language for the user.

The content of the retrieved journal article can be summarized in the form of coursework or a seminar (e.g., a series of slides and/or lecture that is audibly read by the education application). In addition to summarizing the content of the retrieved journal article, the artificial intelligent and/or machine learning tool is configured to generate one or more questions and answers (e.g., a multiple choice question having one or more correct answers). based on the content of the retrieved journal article. The generated questions to be used to test a user's understanding of the retrieved journal article. The retrieved journal article and the generated questions are reviewed and once accepted, may be used as part of the continuing education application.

Professionals may be recruited and on-boarded as contractors to review the retrieved journal article and the generated questions using a web-based or mobile application interface. As these professionals are currently practicing in their profession (let us assume this is limited to medicine for the sake of discussion, but the embodiments are not so limited), then they bring with them expertise in one or more areas of the medical arts. Additionally, the retrieved journal articles and the corresponding generated questions can be put through a multi-level peer-review process.

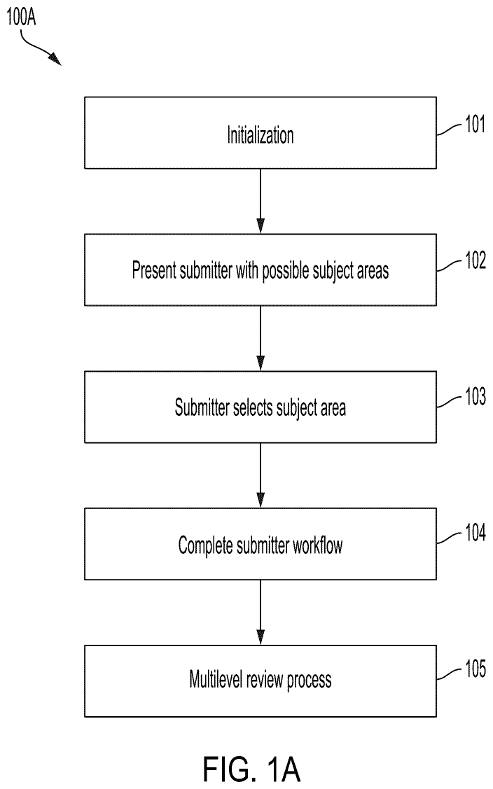

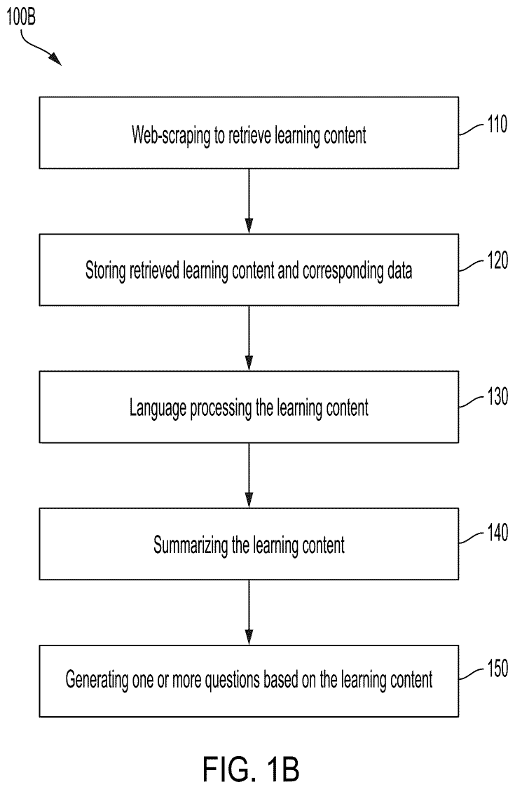

FIG. 1A illustrates a flow diagram of functionality 100A for generating educational content according to an example embodiment of the present invention.

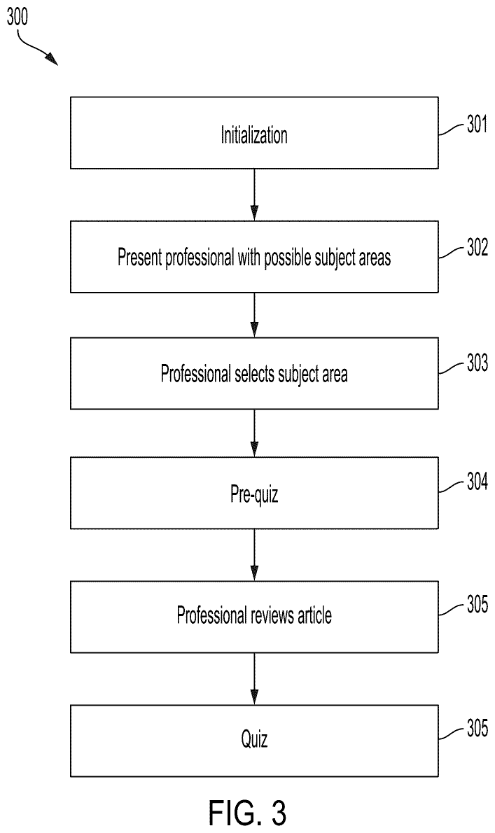

In some instances, the functionality of the flow diagram of FIG. 1A (and FIG. 1B, and FIG. 3, below) is implemented by software stored in memory or other non-transitory computer-readable or tangible media, and executed by one or more processors. In other instances, the functionality may be performed by hardware (e.g., through the use of an application specific integrated circuit (“ASIC”), a programmable gate array (“PGA”), a field programmable gate array (“FPGA”), processor, etc.), or any combination of hardware and software functionally.

At the outset, functionality 100 may optionally initialize the portable electronic device, at 101. For example, functionality 100 may determine or otherwise initialize the respective configurations of the various components of the portable electronic device for execute on of the education application.

Next at 102, one or more submitters log into the educational application and is/are presented with a listing of subjects (or articles) for content generation (e.g., in table or listing format). Each article may be associated payout for the submitter. Submitters are typically professionals currently practicing in their profession, and bring with them expertise in one or more subject/educational areas. By recruiting submitters in particular subject areas, the educational content is crowdsourced.

For example, the journal articles may be retrieved using any of a variety of commercially-available web-scraping applications (e.g., PubMed Web Scraper, ParseHub, Diffbot, etc.), periodically (e.g., daily, weekly, monthly, quarterly, etc.) retrieving journal articles published in peer-reviewed high-impact journals. Other scholarly content or learning content can be retrieved and stored. Although journal articles are used as an example, the embodiments are not so limited.

Subsequently, based on the submitter's individual area of expertise and desired payment, the submitter selects a subject that they wish to submit content on, at 103. In the medical context, PubMed is utilized, for example. There submitter(s) identify one or more research articles, meta-analyses, review articles, and/or practice guidelines that meets their subject area of interest and/or their desired payout. Here, the submitter(s) selects a research article or the like and reviews it to develop educational content. Additionally, or alternatively, the submitter may develop subject area in the form of coursework or a seminar.

At 104, after the submitter has reviewed an article for education content, the submitter is guided through a submitter's workflow in the educational application. Here, key information about the article, such as the PubMed ID (to facilitate automated download of article content), medical specialties and subspecialties to which the article applies (e.g., as tags or metadata), one or more relevant keywords, and a series of multiple choice questions which are to be used as part of a continuing medical education activity focused on this article, are retrieved from the submitter and electronically stored at an application server or cloud based devices. Here, the key information may be proposed using artificial intelligence and/or machine learning, and the proposed key information may be reviewed and validated by the submitter.

Lastly, submitted educational content and associated information undergo a multi-level peer-review process, and once final approval of the content is received, an automated payment corresponding to the free-market rate is sent to the submitter, at 105.

FIG. 1B illustrates a flow diagram of functionality 100B for generating educational content according to another example embodiment of the present invention. In this embodiment, the continuing education application is an artificial intelligence and/or machine learning system for generation of mass content for continuing education for physicians or other professionals.

At the outset, at 110, the any of a variety of commercially-available web-scraping applications (e.g., PubMed Web Scraper, ParseHub, Diffbot, etc.), can be used to periodically (e.g., daily, weekly, monthly, quarterly, etc.) retrieve journal articles published in peer-reviewed high-impact journals, and available for download via an Internet-based repository (e.g., a database). The retrieved journal articles and corresponding data (e.g., title, abstract, authorship, key words, metadata, article text and figures, etc.) can be stored on one or more web-servers and/or one or more cloud-based storage systems, at 120. Other scholarly content or learning content can be retrieved and stored. Although journal articles are used as an example, the embodiments are not so limited.

In this embodiment, instead of using professionals in respective disciplines (or industries), the embodiment utilizes any of a variety of commercially-available artificial intelligent or machine learning tools (e.g., ChatGPT, ChatDoc, ChatPDF, Unriddle, etc.) to language process the retrieved journal articles using a neural network architecture, at 130. In most artificial intelligence or machine learning models, the neural networks enable language processing through complex mathematical functions utilizing numerical data as input. Therefore, the language processing encodes the input text into numerical data before being supplied to the neural network. Similarly, the numerical output of the neural networks is decoded to natural language for the user.

Next, at 140, the content of the retrieved journal article can be summarized in the form of coursework or a seminar (e.g., a series of slides and/or lecture that is audibly read by the education application). In addition to summarizing the content of the retrieved journal article, the artificial intelligent and/or machine learning tool is configured to generate one or more questions (e.g., a multiple choice question having one or more correct answers) based on the content of the retrieved journal article, at 150. The generated questions to be used to test a user's understanding of the retrieved journal article. The retrieved journal article and the generated questions are reviewed and once accepted, may be used as part of the continuing education application.

Lastly, at 160, professionals may be recruited and on-boarded as contractors to review the retrieved journal article and the generated questions using a web-based or mobile application interface. As these professionals are currently practicing in their profession (let us assume this is limited to medicine for the sake of discussion, but the embodiments are not so limited), then they bring with them expertise in one or more areas of the medical arts. Additionally, the retrieved journal articles and the corresponding generated questions can be put through a multi-level peer-review process.

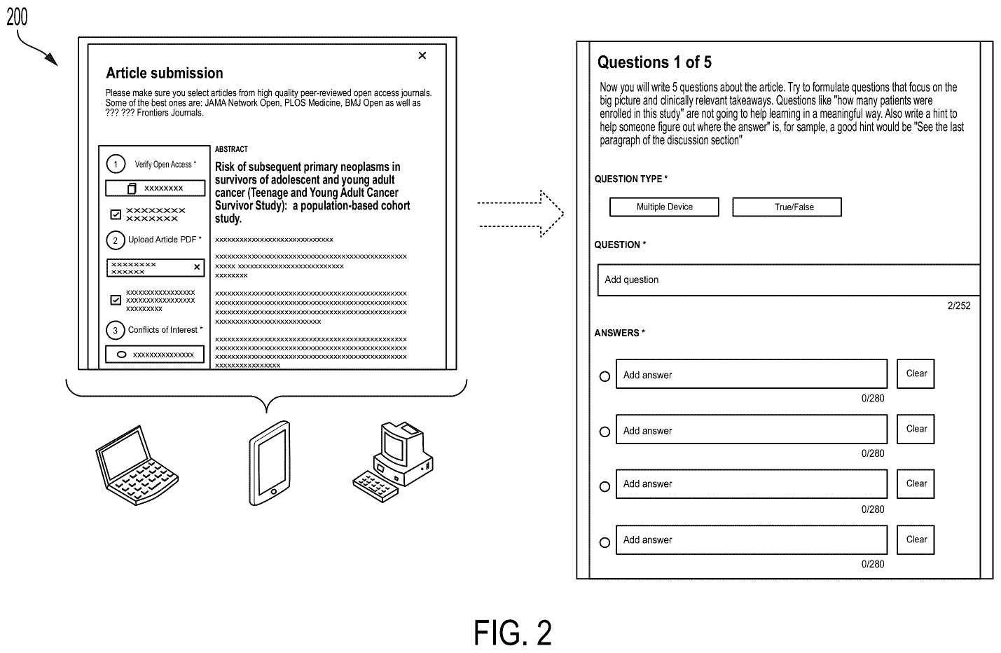

FIG. 2 illustrates an example user interface 200 according to an example embodiment of the present invention. As illustrated in FIG. 2, a submitter submits an article and a series of questions.

FIG. 3 illustrates a flow diagram of functionality 300 for continuing education according to an example embodiment of the present invention.

At the outset, functionality 300 may optionally initialize the portable electronic device, at 301. For example, functionality 300 may determine or otherwise initialize the respective configurations of the various components of the portable electronic device for execution of the education application.

Next at 302, one or more professionals seeking continuing education log into the educational application and is/are presented with a listing of subjects (or articles) for continuing education. Professionals seeking continuing education are typically professionals currently practicing in their profession and desiring to expand and/or update their skill sets in one or more subject/educational areas.

Subsequently, at 303, a respective professional identifies an article for continuing education. At 304, and before reviewing the article, the professional may be presented with a pre-quiz to assess the professional's knowledge in the subject area.

In turn, the professional is presented with the article for continuing education, at 305. Lastly, after reviewing the article, the professional is presented with a quiz and based on the result of the quiz, the professional may be eligible for continuing education credit, at 306.

In most CME programs, after the course is completed, a course evaluation is completed to assess the usefulness of the course. However, the answers a physician leaves on the course evaluation are quite subjective. In our method, the questions from the pre-quiz may be a subset of the same questions from the quiz. By comparing the answers of the pre-quiz and quiz, the embodiments may quantitatively assess the improvement in the professional's knowledge, competence, and performance.

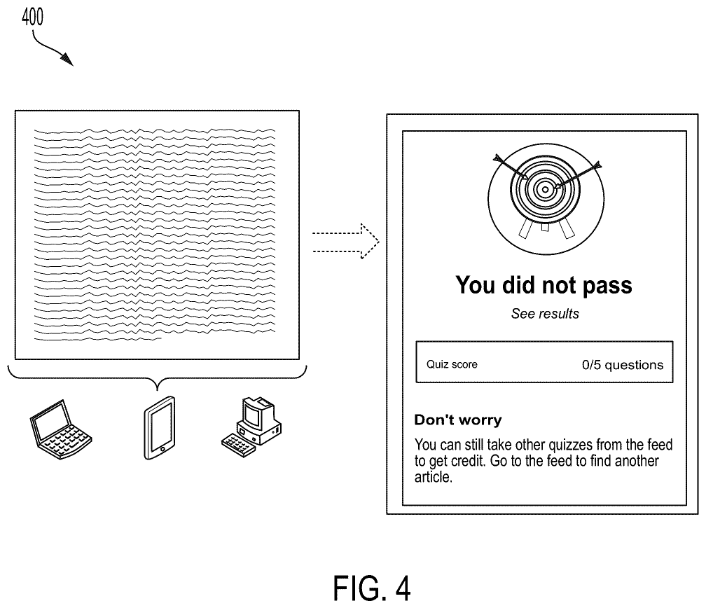

FIG. 4 illustrates an example user interface 400 according to an example embodiment of the present invention. As illustrated in FIG. 4, the professional is presented with an article and takes a quiz to determine eligibility for continuing education credit.

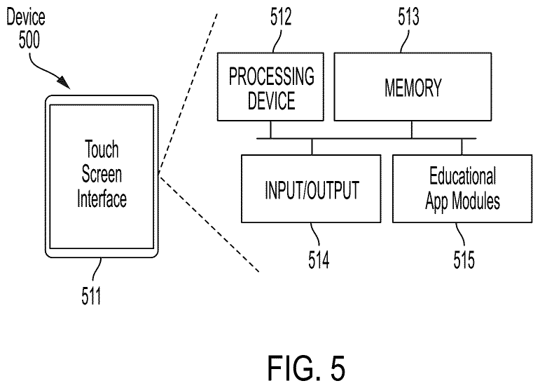

FIG. 5 illustrates a representative architecture of a portable electronic device according to an example embodiment.

A portable electronic device 500 may include a touch screen interface 511, processing device 512, memory 513, and input/output module 514. The touch screen interface 511 may include a display, which may be a touch screen, capable of displaying data to a user of the portable electronic device 500. Portable electronic device 500 may also include one or more education modules 515 that generally implements the functionality of the education application. The components and functions of the one or more education module 515 are described herein.

Although not shown, the touch screen may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor. The input/output module 514 manages the functionality of touch screen interfaced 511. For example, input/output module 514 may include functionality for identifying a component section within the education application. An alternate component section may be selected by touching the alternate component section.

Memory 513 may include a non-transitory computer readable medium storing application modules, which may include instructions associated with applications and modules of the portable electronic device 500.

The portable electronic device may contain a processing device 512, memory 513, and a communications device (not shown), all of which may be interconnected via a system bus. In various embodiments, the device 500 may have an architecture with modular hardware and/or software systems that include additional and/or different systems communicating through one or more networks via one or more communications devices.

Communications devices may enable connectivity between the processing devices 512 in the device 500 and other systems by encoding data to be sent from the processing device 512 to another system over a network and decoding data received from another system over the network for the processing device 512.

In an embodiment, memory 513 may contain different components for retrieving, presenting, changing, and saving data and may include computer readable media. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system. Memory 513 may be capable of storing user inputs and preferences as well as customized displays and templates.

Processing device 512 may perform computation and control functions of a system and comprises a suitable central processing unit (CPU). Processing device 512 may include a single integrated circuit, such as a micro-processing device, or may include any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the disclosure to the precise forms disclosed. For example, although the processing device 512 is shown as separate from the modules 514 and 515 and the touch screen interface 511, in some instances the processing device 512 and the touch screen interface 511 and/or one or more of the modules 514 and 515 may be functionally integrated to perform their respective functions.

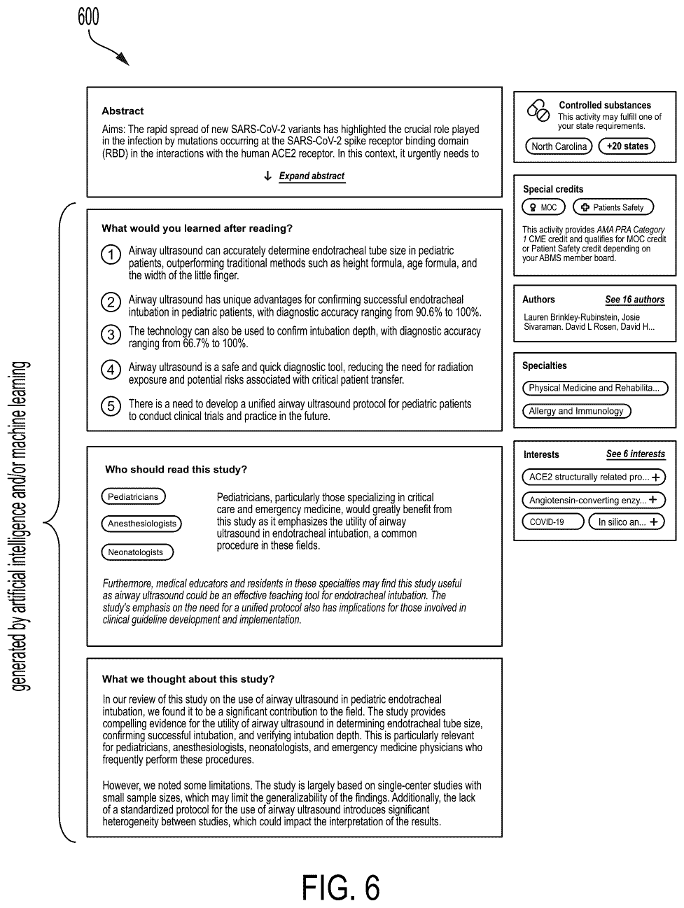

FIG. 6 illustrates an example user interface 600 according to an example embodiment of the present invention. As illustrated in FIG. 6, content such as what would you learn after reading and who should read this study are generated by artificial intelligence and/or machine learning based on language processing of the learning content (e.g., a journal article).

It will be apparent to those skilled in the art that various modifications and variations may be made in the mass generation of content for education applications of the present invention without departing from the spirit or scope of the invention. Thus, it is intended that the present invention cover the modifications and variations of this invention provided they come within the scope of the appended claims and their equivalents.

What is claimed is:

1. A device for generation of content for an education application, the device comprising:
a processor; and
a non-transitory memory storing one or more programs for execution by the processor, the one or more programs including instructions for:
periodically web-scraping a repository of learning content;
storing the learning content and corresponding information;
language processing the learning content using a neural network architecture;
using artificial intelligence or machine learning to summarize the learning content; and
using artificial intelligence or machine learning to generate one or more questions and answers for the education application based on the learning content.

2. The device for generation of content for the education application according to claim 1, wherein the corresponding information includes one or more of a title, abstract, authorship, key words, metadata, and article text and figures.

3. The device for generation of content for the education application according to claim 1, wherein the education application is a continuing education application.

4. The device for generation of content for the education application according to claim 1, wherein the learning content is summarized in the form of coursework or a seminar.

5. The device for generation of content for the education application according to claim 4, wherein the summarized includes a series of slides and/or lecture that is audibly read by the education application.

6. The device for generation of content for continuing education according to claim 1, wherein the one or more questions are multiple choice.

7. A non-transitory computer readable storage medium storing one or more programs for generation of content for an education application configured to be executed by a processor, the one or more programs comprising instructions for:
periodically web-scraping a repository of learning content;
storing the learning content and corresponding information;
language processing the learning content using a neural network architecture;
using artificial intelligence or machine learning to summarize the learning content; and
using artificial intelligence or machine learning to generate one or more questions and answers for the education application based on the learning content.

8. The non-transitory computer readable storage medium for generation of content for education application according to claim 7, wherein the corresponding information includes one or more of a title, abstract, authorship, key words, metadata, and article text and figures.

9. The non-transitory computer readable storage medium for generation of content for education application according to claim 7, wherein the education application is a continuing education application.

10. The non-transitory computer readable storage medium for generation of content for education application according to claim 7, wherein the learning content is summarized in the form of coursework or a seminar.

11. The non-transitory computer readable storage medium for generation of content for education application according to claim 10, wherein the summarized includes a series of slides and/or lecture that is audibly read by the education application.

12. The non-transitory computer readable storage medium for generation of content for education application according to claim 7, wherein the one or more questions are multiple choice.

13. A device for generation of content for an education application, the device comprising:
a processor; and
a non-transitory memory storing one or more programs for execution by the processor, the one or more programs including instructions for:
retrieving learning content from a repository;
storing the learning content and corresponding information;
receiving from a submitter a summary of the learning content; and
receiving from a submitter one or more questions and answers for the education application based on the learning content.

14. The device for generation of content for the education application according to claim 13, wherein the corresponding information includes one or more of a title, abstract, authorship, key words, metadata, and article text and figures.

15. The device for generation of content for the education application according to claim 13, wherein the education application is a continuing education application.

16. The device for generation of content for the education application according to claim 13, wherein the learning content is summarized in the form of coursework or a seminar.

17. The device for generation of content for the education application according to claim 16, wherein the summarized includes a series of slides and/or lecture that is audibly read by the education application.

18. The device for generation of content for continuing education according to claim 13, wherein the one or more questions are multiple choice.
